(19) United States
(12) Patent Application Publication
(10) Pub. No.: US 2022/0410037 A1
(43) Pub. Date: Dec. 29, 2022

(54) POLYESTER DEMULSIFIER

(71) Applicant: NOURYON CHEMICALS INTERNATIONAL B.V., ARNHEM (NL)

(72) Inventor: Hanamanthsa Shankarsa BEVINAKATTI, Somerset, NJ (US)

(73) Assignee: NOURYON CHEMICALS INTERNATIONAL B.V., ARNHEM (NL)

(21) Appl. No.: 17/303,861

(22) Filed: Jun. 9, 2021

(51) Int. Cl. B01D 17/04; C08G 63/668; B01F 17/00; C10G 33/04

(52) U.S. Cl. CPC B01D 17/047; C08G 63/668; B01F 17/0028; C10G 33/04

(57) ABSTRACT

A demulsifier includes the reaction product of a) a combination of a monoglyceride and polyethylene glycol (PEG), b) an acid having at least two carboxyl groups, a full or partial ester thereof, an anhydride thereof and combinations thereof, and c) optionally, a fatty acid, a fatty alcohol and combinations thereof. A method of demulsifying a water-in-oil or oil-in-water emulsion includes adding the demulsifier to the emulsion and separating the emulsion into an oil phase and a water phase.

### CROSS-REFERENCE TO RELATED APPLICATION

This application is a U.S. National-Stage entry under 35 U.S.C. § 371 based on International Application No. PCT/EP2019/084757, filed Dec. 11, 2019 which was published under PCT Article 21(2) and which claims priority to European Patent Application No. 19152550.0, filed Jan. 18, 2019, and claims priority to U.S. Provisional Application No. 62/777,903, filed Dec. 11, 2018 which are all hereby incorporated in their entirety by reference.

### BACKGROUND

Oil extraction is the removal of oil from an oil reservoir. Oil is often recovered from a reservoir as a water-in-oil emulsion. Crude oil typically contains appreciable quantities of water as part of a crude oil emulsion. Demulsifiers are chemical compounds used to separate water-in-oil and/or oil-in-water emulsions into separate water and oil phases, and are commonly used to remove water from crude oil. It is desirable to remove water from crude oil shortly after extraction, as oil extractors prefer to store and/or ship “dry” oil (i.e. oil with low concentrations of water). Storing water with the oil takes up space on oilfield installations, and shipping crude oil containing a significant amount of water to an oil refinery is both expensive and inefficient. Thus, oil extractors aim to demulsify crude oil emulsions at the earliest after extraction and in particular at offshore platforms where space is typically limited.

Most state of the art demulsifier compositions are environmentally unfriendly. However, many environmentally friendly demulsifier compositions have performance limitations, and they typically do not work as well as those that are less-friendly. Currently used demulsifiers that are environmentally unfriendly may be banned from future use. Thus, a need exists for environmentally friendly demulsifier compositions that possess similar or superior properties to standard (less-friendly) demulsifiers. This disclosure describes such demulsifier compositions.

### BRIEF SUMMARY

This disclosure provides a demulsifier comprising the reaction product of:

a) a combination of a monoglyceride and polyethylene glycol (PEG);
b) an acid having at least two carboxyl groups, full or partial esters thereof, an anhydride thereof or combinations thereof; and
c) optionally, a fatty acid, a fatty alcohol or combinations thereof.

This disclosure also provides a method of making a demulsifier comprising the step of:

reacting a) a combination of a monoglyceride and polyethylene glycol (PEG) with b) an acid having at least two carboxyl groups, full or partial esters thereof, anhydrides thereof or combinations thereof and, optionally, a fatty acid, a fatty alcohol or combinations thereof.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description.

A demulsifier comprises the reaction product of a) a combination of a monoglyceride and polyethylene glycol (PEG), b) an acid having at least two carboxyl groups, a full or partial ester thereof, an anhydride thereof and combinations thereof, and c) optionally, a fatty acid, a fatty alcohol, and combinations thereof.

A method of demulsifying an emulsion, wherein the emulsion is a water-in-oil emulsion or an oil-in-water emulsion is also provided. The method comprises the steps of adding the demulsifier to the emulsion, the water component of the emulsion, and/or the oil component of the emulsion, and separating the emulsion into an oil phase and a water phase.

A method of making a demulsifier composition is also provided. The method comprises the step of reacting a) a combination of a monoglyceride and PEG with b) an acid having at least two carboxyl groups, a full or partial ester thereof, an anhydride thereof and combinations thereof and, optionally, a fatty acid, a fatty alcohol, and combinations thereof.

A demulsifier according to this disclosure includes the reaction product of a) (i) an alkoxylated monoglyceride, (ii) a combination of an alkoxylated polyol and a fatty acid, and (iii) a combination of a monoglyceride and PEG, with b) an acid having at least two carboxyl groups, full or partial esters thereof, an anhydride thereof and combinations thereof. In another embodiment, the demulsifier includes the reaction product of a) (i) an alkoxylated monoglyceride, (ii) a combination of an alkoxylated polyol and a fatty acid and (iii) a combination of a monoglyceride and PEG; b) an acid having at least two carboxyl groups, full or partial esters thereof, an anhydride thereof and combinations thereof, and c) a fatty acid, a fatty alcohol and combinations thereof. In still another embodiment, the demulsifier includes the reaction product of a) a combination of a monoglyceride and PEG, b) an acid having at least two carboxyl groups, full or partial esters thereof, an anhydride thereof and combinations thereof, and c) optionally, a fatty acid, a fatty alcohol and combinations thereof. The disclosed demulsifier separates oil-in-water and/or water-in-oil emulsions. The water-in-oil emulsions are typically observed in crude oil.

Polyol alkoxylate derivatives. An alkoxylated monoglyceride, a combination of an alkoxylated polyol and a fatty acid, and a combination of a monoglyceride and PEG, once reacted according to the present disclosure, may all be considered polyol alkoxylate derivatives. Depending on the selection, the location of the alkoxylate moiety in the final demulsifier may be different. Each of these “derivatives” will be described in further detail below.

Monoglycerides are compounds having a glycerol moiety linked to a fatty acid via an ester bond. The fatty acid may be linked to either a primary alcohol or the secondary alcohol of the glycerol moiety. The following structure (1) illustrates one embodiment of a monoglyceride:

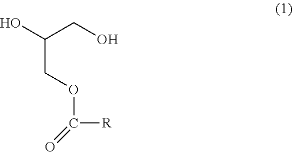

where R is the alk(en)yl component of the fatty acid. In some embodiments, the R group is an alkenyl group having from about 7 carbon atoms to about 21 carbon atoms. Commercially available monoglycerides are typically not “pure” but instead contain a mixture of monoglycerides, diglycerides and triglycerides. As used herein, the term “monoglyceride” refers to products in which the monoglyceride moiety is the most prevalent.

PEG. Polyethylene glycol or PEG is a polyether having the general formula H—(O—CH2-CH2)n-OH. The number n may vary and determines whether a particular PEG has a low molecular weight or a high molecular weight. In some embodiments, the PEG used in the demulsifier described herein has a number n between about 4 and about 200. Suitable PEGs include PEG 200, PEG 400, PEG 600, PEG 1000, PEG 1450, PEG 2000 and PEG 8000 where the number following “PEG” is the approximate (± about 5%) average molar mass (g/mol) of the PEG. For example, PEG 400 has an average molar mass between about 380 g/mol and about 420 g/mol. PEGs having other molecular weights may also be used.

Alkoxylated monoglyceride. Alkoxylation is a reaction that involves the addition of an epoxide (a cyclic ether) to a compound. Suitable epoxides for alkoxylation of monoglycerides include ethylene oxide (C2H4O), propylene oxide (CH3CHCH2O) and epoxy butanes. Once alkoxylated, it is expected that the hydroxyl and ester groups of the monoglyceride will be linked to alkoxy groups (e.g., ethyleneoxy, propoxy, etc.). In an embodiment, the alkoxylated monoglyceride is ethoxylated monoglyceride. One example of an ethoxylated monoglyceride is shown in the diagram (2) below:

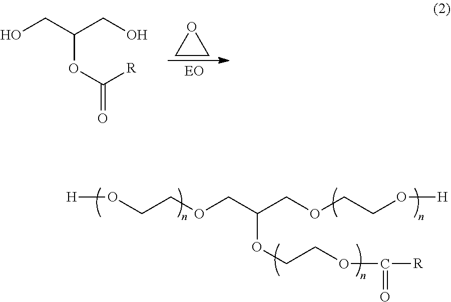

The extent of alkoxylation of alkoxylated monoglycerides may vary. Different alkoxylation sites, each hydroxyl group and the ester linkage, may contain different numbers of alkoxy groups. In some embodiments, each mole of alkoxylated monoglyceride contains, on average, between about 5 alkoxy units and about 40 alkoxy units (i.e., from about 5 to about 40 moles of alkoxy units per mole of monoglyceride). In some embodiments, the about 5 alkoxy units to about 40 alkoxy units are ethyleneoxy units. In other embodiments, each mole of alkoxylated monoglyceride contains, on average, less than about 8 propyleneoxy units.

Alkoxylated polyol. Alkoxylated polyols or polyol alkoxylates, such as alkoxylated glycerol, are commercially available. Like alkoxylated monoglycerides, polyol alkoxylates contain linkages to alkoxy groups at hydroxyl sites. For example, the following structure (3) illustrates an ethoxylated glycerol:

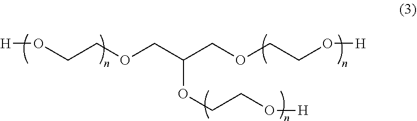

In some embodiments, the polyol (in its unalkoxylated form) contains from about 3 to about 6 carbon atoms. In some embodiments, the polyol contains 3 or 4 hydroxyl groups. In some embodiments, the ratio of primary alcohols to secondary alcohols on the polyol (unalkoxylated) is from about 2:1 to about 4:0, or about 2:1, or about 3:0, or about 4:0. Suitable alkoxylated polyols include glycerol alkoxylates, pentaerythritol alkoxylates, and trimethylolpropane alkoxylates.

Fatty acid. Fatty acids have the general formula R—COOH where R is an alk(en)yl or an aryl group. An alk(en)yl R group may be saturated or unsaturated, linear or branched and cycloalkyl or aryl. In some embodiments, the R group contains between about 7 carbon atoms and about 21 carbon atoms. In these embodiments, the fatty acid has between about 8 and about 22 carbon atoms in total. A mixture of fatty acids may be present. Suitable fatty acids include tallow fatty acids, tall oil fatty acids, coconut fatty acids, palmitic acid, stearic acid, myristic acid, oleic acid, palmitoleic acid, linoleic acid, linolenic acid, lauric acid, decanoic acid, caprylic acid and combinations thereof. In some embodiments, a majority of the fatty acid contains chains having between about 12 and about 18 carbon atoms.

Carboxylic acid. The acid having at least two carboxyl groups may have two, three or four carboxyl (—COOH) groups. The acid having at least two carboxyl groups may be linear or branched and saturated or unsaturated. When two carboxyl groups are present and the acid is linear, the acid is a dicarboxylic acid and has the general formula HOOC(CH2)nCOOH. In some embodiments, n has a value between about 2 and about 34. In these embodiments, the acid has between about 4 and about 36 carbon atoms in total. The value of n may be the same for branched acids. Suitable acids include succinic acid, adipic acid, glutaric acid, sebacic acid, and combinations thereof. When three carboxyl groups are present, the acid is a triacid. Suitable triacids include citric acid (C6H807). When four carboxyl groups are present, the acid is a tetracid. Suitable examples of branched acids include itaconic acid and citraconic acid. In an embodiment, the acid having at least two carboxyl groups comprises an acid selected from succinic acid, adipic acid, glutaric acid, citric acid, and combinations thereof.

Ester. A full or partial ester of the acids described above may be used in place of the above acid. For example, in the case of a linear dicarboxylic acid, a full ester (diester) has the general formula R1OOC(CH2)nCOOR2 where R1 and R2 are alkyl or aryl groups. In some embodiments, n has a value between about 2 and about 34. R1 and R2 may be different alkyl or aryl groups or the same. In a partial ester, less than all the carboxylic acid groups are replaced with an ester group. In some embodiments, both an acid having at least two carboxyl groups and a full or partial ester are used to produce the demulsifier.

Anhydride. An organic acid anhydride may be used in place of the above carboxylic acid. An anhydride of a linear dicarboxylic acid has the general formula R1(CO)—O—(CO)R2 where R1 and R2 are alkyl or aryl groups. R1 and R2 may be different alkyl or aryl groups or the same. Suitable organic acid anhydrides include succinic anhydride, maleic anhydride, alkenyl succinic anhydride, itaconic anhydride, citraconic anhydride and combinations thereof. In some embodiments, both an acid having at least two carboxyl groups and an organic acid anhydride are used to produce the demulsifier.

In some embodiments, the demulsifier is the reaction product of (i) an alkoxylated monoglyceride and (ii) a combination of a monoglyceride and polyethylene glycol (PEG); an acid having at least two carboxyl groups, a full or partial ester thereof, an anhydride thereof and combinations thereof (as described above); and a fatty acid, a fatty alcohol and combinations thereof.

Fatty acid. When used in the embodiment described in the preceding paragraph, the fatty acid has the same properties as the fatty acid previously described. the fatty acid has the general formula R—COOH where R is an alkyl or an aryl group. An alkyl R group may be saturated or unsaturated, linear or branched, and cycloalkyl or aryl. In some embodiments, the R group contains between about 7 carbon atoms and about 21 carbon atoms. In these embodiments, the fatty acid has between about 8 and about 22 carbon atoms in total. A mixture of fatty acids may be present. Suitable fatty acids include tallow fatty acids, tall oil fatty acids, coconut fatty acids, palmitic acid, stearic acid, myristic acid, oleic acid, dibasic acid, palmitoleic acid, linoleic acid, linolenic acid, lauric acid, decanoic acid, caprylic acid and combinations thereof. In an embodiment, the fatty acid comprises an acid selected from tallow fatty acids, tall oil fatty acids, palmitic acid, stearic acid, myristic acid, oleic acid, dibasic acid, palmitoleic acid, linoleic acid, linolenic acid, and combinations thereof. In some embodiments, a majority of the fatty acid contains chains having between about 12 and about 18 carbon atoms.

Fatty alcohol. When used, the fatty alcohol has the general formula R—OH where R is an alkyl group. The R group may be saturated or unsaturated and linear or branched. In some embodiments, the R group contains between about 6 carbon atoms and about 22 carbon atoms. A mixture of fatty alcohols may be present. Suitable fatty alcohols include decyl alcohol, lauryl alcohol, cetyl alcohol, stearyl alcohol, isostearyl alcohol, oleyl alcohol and combinations thereof. In some embodiments, a majority of the fatty alcohols contain chains having between about 12 and about 18 carbon atoms. In some embodiments, both a fatty acid and a fatty alcohol are used to produce the demulsifier.

The molar ratio of the polyol alkoxylate derivatives to the acid having at least two carboxyl groups, full or partial ester thereof, the anhydride thereof and combinations thereof is between about 1:3 and about 5:1, or between about 1:2 and about 2:1. The molar ratio of polyol alkoxylate derivatives to the fatty acid, the fatty alcohol and combinations thereof, when used, is between about 1:3 and about 5:1, or between about 1:2 and about 2:1.

In some embodiments, the combination of both a glycerol ethoxylate and a monoglyceride as reactants is avoided.

The reaction product is prepared by reacting the selected polyol alkoxylate “derivative”; the acid having at least two carboxyl groups, full or partial ester thereof, the anhydride thereof and combinations thereof; and, optionally, the fatty acid, the fatty alcohol and combinations thereof described herein. The reaction may occur without using any catalyst or in the presence of a basic or acidic catalyst. Suitable base catalysts include sodium hydroxide, potassium hydroxide, sodium carbonate, potassium carbonate. Suitable acid catalysts include phosphorous acid, hypophosphorous acid, hypophosphoric acid, and para-toluenesulfonic acid monohydrate. The reaction may proceed at temperatures up to about 200° C. in a nitrogen environment and/or under vacuum conditions (e.g., from about 7 to about 20 kPa).

The reaction product yielded by the above reaction conditions is a polyester suitable for use as a demulsifier. When the polyol alkoxylate derivative is a combination of monoglyceride and PEG, it is believed that a compound having the following structure (4) is predominantly produced:

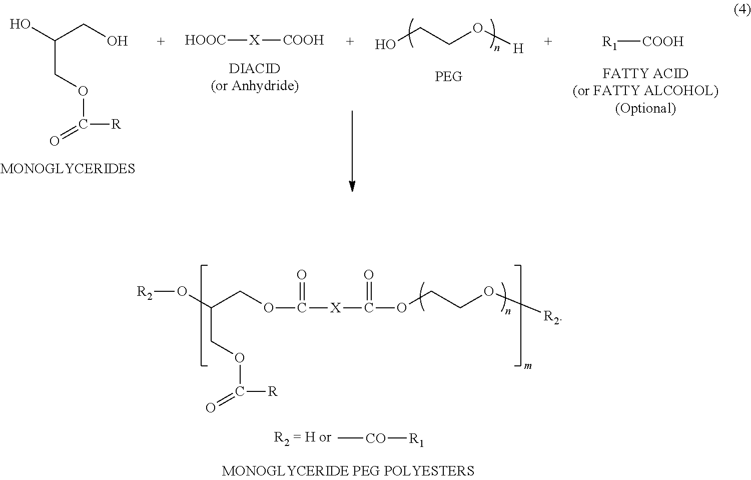

The presence of the optional fatty acid or fatty alcohol affects the end caps of the demulsifier with R2 being hydrogen, —(CO)R1 (a fatty acid), or a fatty alcohol residue. In some embodiments, m is a number between about 1 and about 50, or between about 2 and about 10. In some embodiments, n is a number between about 4 and about 200.

In an embodiment, the monoglyceride is glycerol monooleate.

When the polyol alkoxylate derivative is an alkoxylated monoglyceride, it is believed that the general reaction pathway shown below is followed, with a compound having the following structure (5) being predominantly produced:

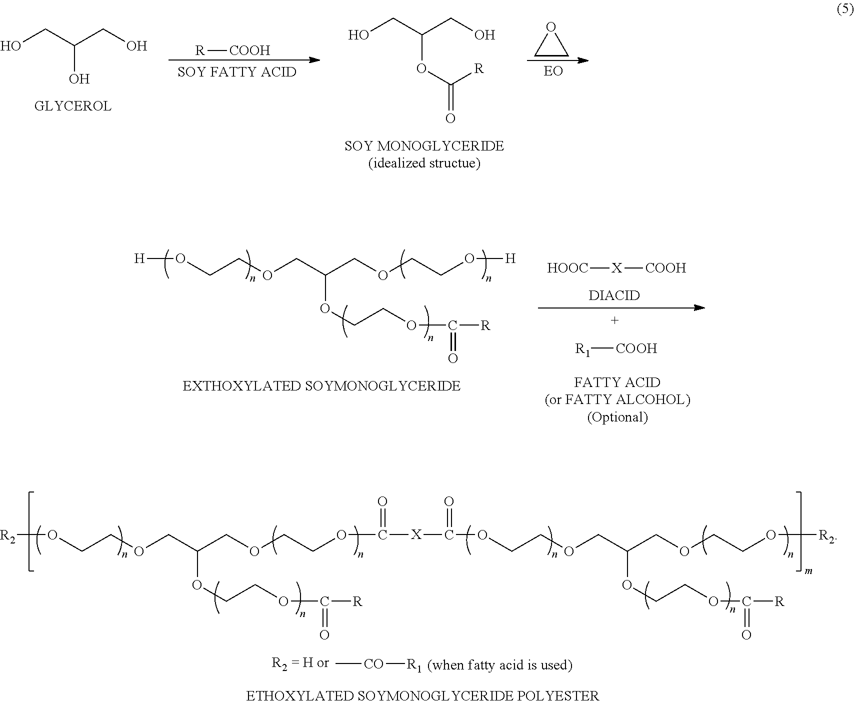

This reaction pathway uses ethoxylated soy monoglyceride as the alkoxylated monoglyceride. Propoxylated monoglycerides and monoglycerides having different fatty acid chains are expected to behave similarly. The presence of the optional fatty acid or fatty alcohol affects the end caps of the demulsifier with R2 being —(CO)R1 (fatty acid) or a fatty alcohol residue. In some embodiments, m is a number between about 1 and about 50, or between about 2 and about 10. In some embodiments, the total of n per alkoxylated monoglyceride residue is a number between about 5 and about 40.

When the polyol alkoxylate derivative is a combination of an alkoxylated polyol and a fatty acid, it is believed that the general reaction pathway shown below is followed, with a compound having the following structure (6) being predominantly produced:

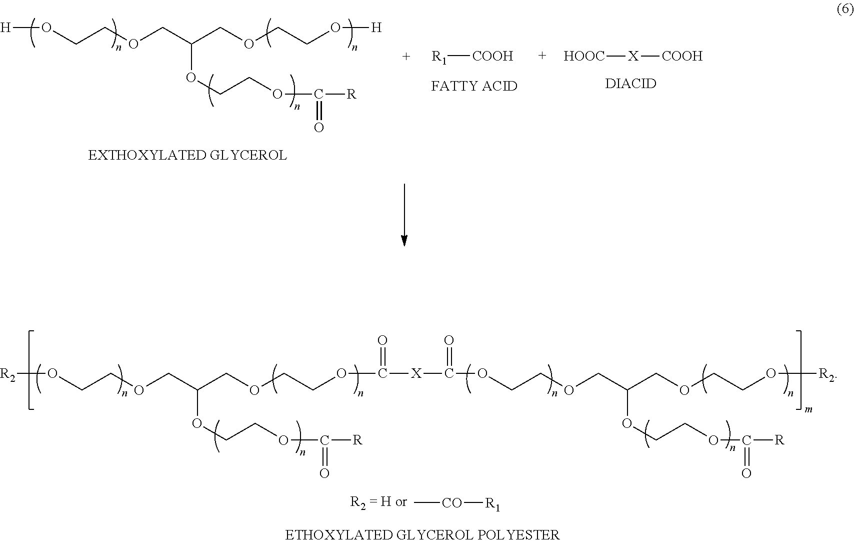

This reaction pathway uses ethoxylated glycerol as the alkoxylated polyol. Propoxylated glycerols and other alkoxylated polyols are expected to behave similarly. Alkoxylated polyols may also contain a mixture of alkoxylates (e.g., some ethyleneoxy units and some propyleneoxy units). In some embodiments, m is a number between about 1 and about 50, or between about 2 and about 10. In some embodiments, the total of n per alkoxylated polyol residue is a number between about 5 and about 40.

The reaction product may also include water. In some embodiments, water is removed from the reaction product so that the total water concentration is below about 5 percent by weight, or less than about 3 percent by weight, or less than about 2 percent by weight, or less than about 1 percent by weight. Alternatively, the water may remain in mixture with the reaction product until after demulsification of the target emulsion.

Alternatively, the reaction product may be thought of as containing monoglyceride residues, PEG-type residues, diacid-type residues and, optionally, fatty acid residues. The PEG-type residues refer to the alkoxylate or PEG groups described herein. The diacid-type residues include the diacid, triacid and tetracid described herein (or the full or partial ester thereof and/or the anhydride thereof). When present, approximately two fatty acid residues, excluding the fatty group present on the monoglyceride residue, are present for each monoglyceride residue, PEG-type residue, and diacid-type residue.

A method according to this disclosure includes a method of making a polyester demulsifier by reacting a) (i) an alkoxylated monoglyceride, (ii) a combination of an alkoxylated polyol and a fatty acid, and (iii) a combination of a monoglyceride and polyethylene glycol (PEG) with b) an acid having at least two carboxyl groups, a full or partial ester thereof, an anhydride thereof and combinations thereof. Alternatively, a method of making a polyester demulsifier includes reacting a) (i) an alkoxylated monoglyceride, (ii) a combination of an alkoxylated polyol and a fatty acid, and (iii) a combination of a monoglyceride and polyethylene glycol (PEG), with b) an acid having at least two carboxyl groups, a full or partial ester thereof, an anhydride thereof and combinations thereof, and c) a fatty acid, a fatty alcohol and combinations thereof. In another embodiment, a method of making a demulsifier includes the step of reacting a) a combination of a monoglyceride and polyethylene glycol (PEG) with b) an acid having at least two carboxyl groups, a full or partial ester thereof, an anhydride thereof and combinations thereof and, optionally, a fatty acid, a fatty alcohol and combinations thereof. Generally, the reaction takes place at temperatures up to about 200° C. in a nitrogen environment and/or under vacuum conditions (e.g., from about 7 to about 20 kPa) for a period of time sufficient to form the polyester demulsifier.

Another method according to this disclosure includes a method of demulsifying an oil-in-water emulsion or a water-in-oil emulsion. The method includes adding an effective amount of the demulsifier prepared by reacting a) a combination of a monoglyceride and polyethylene glycol (PEG) with b) an acid having at least two carboxyl groups, a full or partial ester thereof, an anhydride thereof and combinations thereof and, optionally, a fatty acid, a fatty alcohol and combinations thereof, described herein, to the emulsion, the water component of the emulsion, and/or the oil component of the emulsion. In some embodiments, the emulsion is a water-in-oil emulsion, such as a crude oil emulsion containing salt water, sea water and/or ocean water. Alternatively, the demulsifier may be added to an oil (e.g., crude oil) before an emulsion is formed with the oil. For instance, the demulsifier may be added to a crude oil upstream of a separator at an oilfield installation. The demulsifier may also be used to prevent emulsification as a nonemulsifier. The method further includes the step of separating the emulsion into an oil phase and a water phase.

The demulsifier described herein may be used alone as a demulsifier or combined with other demulsifiers to separate the phases of oil-in-water and/or water-in-oil emulsions. The exact composition of a demulsifier formulation (the demulsifier described herein alone or used in combination with other demulsifiers, droppers and/or dryers) may vary depending on the properties of the targeted emulsion. Crude oils obtained from the same well may change over time and changing environmental conditions (e.g., temperature, pressure) may require changes to the demulsification formulation in order to maintain effectiveness.

The demulsifier formulation may be used at a concentration between about 1 part per million (ppm) and about 1000 ppm. In some embodiments, the demulsifier formulation is used at a concentration between about 5 ppm and about 500 ppm. In some other embodiments, the demulsifier formulation is used at a concentration between about 10 ppm and about 400 ppm. In still other embodiments, the demulsifier formulation is used at a concentration between about 20 ppm and about 200 ppm.

### EXAMPLES

For illustrative purposes, the following examples are disclosed. All percentages used are by weight unless otherwise stated.

### Example 1. Preparation of Ethoxylated Soy Monoglyceride (10 EO) Polyester

318 grams of ethoxylated soy monoglyceride (sourced from Nouryon), 47 grams of adipic acid (Alfa Aesar), and 1.7 grams of phosphorous acid catalyst (Acros Organics) were added to a 500-mL flask. On average, the ethoxylated soy monoglyceride contained 10 moles of ethyleneoxy units for each mole of ethoxylated soy monoglyceride. The flask was flushed with nitrogen gas. While the flask contents were mixed the flask was heated in an oil bath at an oil bath temperature of 200° C. After about two hours of mixing, a vacuum was applied to the flask. After about eight hours of mixing, the acid value reached a constant value and the reaction product was cooled to about 80° C. and then collected. Approximately 3.5 grams of water was removed from the flask before the vacuum was applied.

### Example 2. Preparation of Ethoxylated Glycerol/TOFA (12 EO) Polyester

850 grams of ethoxylated glycerol, 161 grams of adipic acid (Alfa Aesar), 384 grams of tall oil fatty acid (Nouryon) and 4.6 grams of para-toluenesulfonic acid were added to a 2-L flask. On average, the ethoxylated glycerol contained 12 moles of ethyleneoxy units for each mole of ethoxylated glycerol. The flask was flushed with nitrogen gas. The pressure in the reactor was reduced to 20 kPa and the reactor was heated to a temperature of 180° C. Once the temperature reached 180° C., full vacuum (7-8 kPa) was applied and the temperature was increased to 200° C. After about eight hours of mixing, the reaction product was cooled to 60° C. and then collected.

### Examples 3. Preparation of Monoglyceride/PEG Polyester

35.6 grams of glycerol monooleate (GMO, 1-Oleoyl-Rac-Glycerol, technical grade of about 40%, available from Millipore Sigma), 20 grams of polyethylene glycol (PEG-200, available from Acros), 21.9 grams of adipic acid (Alfa Aesar), and 0.4 grams of NaOH catalyst (used as a 50 wt % solution in water) were added to a 100 mL 3-neck flask immersed in an oil bath and set up with downward distillation, magnetic stirrer, thermometer, and an N2 inlet. No fatty acid was added. The flask was flushed with N2 gas and heated to 220° C. under stirring until the acid value stabilized. The reaction product was cooled to around 60° C. and then collected.

### Example 4. Preparation of Monoglyceride/PEG Polyester

24.92 grams of glycerol monooleate (GMO, 1-Oleoyl-Rac-Glycerol, technical grade of about 40%, available from Millipore Sigma), 42 grams of polyethylene glycol (PEG-600, available from Acros), 15.33 grams of adipic acid (Alfa Aesar), and 0.28 grams of NaOH catalyst (used as a 50 wt % solution in water) were added to a 100 mL 3-neck flask immersed in an oil bath and set up with downward distillation, magnetic stirrer, thermometer, and an N2 inlet. No fatty acid was added. The flask was flushed with N₂ gas and heated to 220° C. under stirring until the acid value stabilized. The reaction product was cooled to around 60° C. and then collected.

### Example 5. Preparation of Monoglyceride/PEG Polyester

21.36 grams of glycerol monooleate (GMO, 1-Oleoyl-Rac-Glycerol, technical grade of about 40%, available from Millipore Sigma), 36 grams of polyethylene glycol (PEG-600, available from Acros), 13.14 grams of adipic acid (Alfa Aesar), 8.34 grams of oleic acid (Voleic OA00 available from Vantage), and 0.24 grams of NaOH catalyst (used as a 50 wt % solution in water) were added to a 100 mL 3-neck flask immersed in an oil bath and set up with downward distillation, magnetic stirrer, thermometer, and an N2 inlet. The flask was flushed with N₂ gas and heated to 220° C. under stirring until the acid value stabilized. The reaction product was cooled to around 60° C. and then collected.

### Example 6. Preparation of Monoglyceride/PEG Polyester

21.36 grams of glycerol monooleate (GMO, 1-Oleoyl-Rac-Glycerol, technical grade of about 40%, available from Millipore Sigma), 36 grams of polyethylene glycol (PEG-200, available from Acros), 26.28 grams of adipic acid (Alfa Aesar), and 0.24 grams of NaOH catalyst (used as a 50 wt % solution in water) were added to a 100 mL 3-neck flask immersed in an oil bath and set up with downward distillation, magnetic stirrer, thermometer, and an N2 inlet. No fatty acid was added. The flask was flushed with N2 gas and heated to 220° C. under stirring until the acid value stabilized. The reaction product was cooled to around 60° C. and then collected.

### Example 7. Preparation of Monoglyceride/PEG Polyester

42.72 grams of glycerol monooleate (GMO, 1-Oleoyl-Rac-Glycerol, technical grade of about 40%, available from Millipore Sigma), 24 grams of polyethylene glycol (PEG-200, available from Acros), 23.76 grams of dibasic acid (dibasic acid flakes available from Invista), and 0.46 grams of p-toluene sulfonic acid catalyst (used as a 50 wt % solution in water) were added to a 100 mL 3-neck flask immersed in an oil bath and set up with downward distillation, magnetic stirrer, thermometer, and an N2 inlet. No fatty acid was added. The flask was flushed with N₂ gas and heated to 220° C. under stirring until the acid value stabilized. The reaction product was cooled to around 60° C. and then collected.

### Example 8. Preparation of Monoglyceride/PEG Polyester

17.80 grams of glycerol monooleate (GMO, 1-Oleoyl-Rac-Glycerol, technical grade of about 40%, available from Millipore Sigma), 30 grams of polyethylene glycol (PEG-200, available from Acros), 19.80 grams of dibasic acid (dibasic acid flakes available from Invista), 13.9 grams of oleic acid (Voleic OA00 available from Vantage), and 0.19 grams of p-toluene sulfonic acid catalyst (used as a 50 wt % solution in water) were added to a 100 mL 3-neck flask immersed in an oil bath and set up with downward distillation, magnetic stirrer, thermometer, and an N2 inlet. The flask was flushed with N2 gas and heated to 220° C. under stirring until the acid value stabilized. The reaction product was cooled to around 60° C. and then collected.

The ethoxylated soy monoglyceride polyester prepared in Example 1 was screened for toxicity and for biodegradability in seawater. Toxicity was assessed using Daphnia magna and algae. Biodegradability in seawater was performed according to the OECD Guideline for Testing of Chemicals, Section 3; Degradation and Accumulation, No. 306: Biodegradability in Seawater, Closed Bottle Test. Table 1 illustrates toxicity and biodegradability test results for the Example 1 ethoxylated soy monoglyceride polyester.

TABLE 1
Toxicity and Biodegradation Results

| | Toxicity (mg/L) | | Biodegradation (%) | | | | | | | |
|---|---|---|---|---|---|---|---|---|---|---|
| Sample | Daphnia | Algae | 7 days | 14 days | 21 days | 28 days | 42 days | 56 days | 84 days | 112 days |
| Example 1 | >100 | >100 | 23 | 30 | 36 | 43 | 50 | 53 | 53 | 53 |

As is stated in the Introduction to Section 3 of the OECD Test Guidelines—Biodegradation and Bioaccumulation (2005), a biodegradation result greater than 20% after 28 days is indicative of potential for (inherent) primary biodegradation in the marine environment.

The toxicity and biodegradation test results in Table 1 demonstrate that the Example 1 ethoxylated soy monoglyceride polyester shows favourable results. It is expected that the Example 2 ethoxylated glycerol/TOFA polyester will provide comparable results to that of Example 1.

The performance of the Example 1 and Example 2 demulsifiers was evaluated by carrying out tests on emulsions of crude oil from the North Sea and synthetic North Sea water. The speed of separation and the clarity (transmission) of the water phase were assessed using a Turbiscan™ Lab Expert instrument (Formulaction SA, France). The Turbiscan™ instrument is an automated, vertical scan analyzer that may be used for studying the stability of concentrated emulsions. It is equipped with a near-infrared light source and detection systems for transmission as well as light scattering (backscattering). The demulsifiers were diluted with/dissolved in butyl diglycol (BDG) to facilitate dosage of small concentrations in the tests.

Table 2 illustrates Turbiscan™ data for Example 1 and Example 2 polyesters in addition to a demulsifier that does not meet the OSPAR regulatory requirements for a “green” demulsifier (Witbreak DGE 169, available from Nouryon). The ppm column indicates the concentration of the demulsifier used in the test. “Avg Transmission” (of the water layer) is the average transmission reading between the 0 distance and the position of the crude oil-water boundary at 40 minutes. “StartTime” is the first non-zero signal of transmission, which is later developed into the water layer at the bottom of the testing vial. “HalfTime” is the time when the crude oil-water boundary reaches the midway height of a completely demulsified mixture (e.g., 8 mm when a completely demulsified mixture has a height of 16 mm in the test vial). “End distance” is the position of the crude oil-water boundary at the end of the experiment (40 minutes). “WaterOut” is the (End distance−height of completely demulsified mixture)/height of completely demulsified mixture×100.

TABLE 2
TurbiscanTM Results

| | | Avg | | | | |
|---|---|---|---|---|---|---|
| | | Trans- | | | | |
| Demul- | | mission | StartTime | HalfTime | WaterOut | End |
| sifier | ppm | (%) | (minutes) | (minutes) | (%) | distance |
| Witbreak | 50 | 63.8 | 0 | 1 | 103 | 16.5 |
| DGE 169 | | | | | | |
| Example 1 | 50 | 73.9 | 6 | 20.8 | 82 | 13.1 |
| Example 2 | 50 | 78.3 | 3 | 18 | 74 | 11.9 |
| Example 3 | 50 | 86.7 | 11 | 38 | 54 | 8.6 |
| Example 4 | 50 | 83.4 | 11 | 38 | 55 | 8.8 |
| Example 5 | 50 | 81.6 | 5 | 29 | 63 | 10.1 |
| Example 6 | 50 | 73.1 | 0 | 0 | 102 | 16.3 |
| Example 7 | 50 | 85.4 | 9 | 30 | 64 | 10.2 |
| Example 8 | 50 | 80.0 | 8 | 23 | 74 | 11.9 |

The Turbiscan™ results demonstrate that the Example 1 and Example 2 ethoxylated glyceride polyesters provide an adequate level of demulsification. The Turbiscan™ results also demonstrate that the Examples 3-8 monoglyceride/PEG polyesters also provide an adequate level of demulsification.

While the present disclosure has been described with reference to exemplary embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiments disclosed, but that the present disclosure will include all embodiments falling within the scope of the appended claims.

What is claimed is:

1. A demulsifier comprising the reaction product of:
a) a combination of a monoglyceride and polyethylene glycol (PEG);
b) an acid having at least two carboxyl groups, full or partial esters thereof, an anhydride thereof or combinations thereof; and
c) optionally, a fatty acid, a fatty alcohol or combinations thereof.

2. The demulsifier according to claim 1, wherein the monoglyceride has the structure: 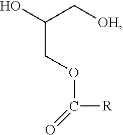
wherein R is an alkenyl group having from about 7 to about 21 carbon atoms.

3. The demulsifier according to claim 1, wherein the monoglyceride is glycerol monooleate.

4. The demulsifier according to claim 1, wherein the monoglyceride is an alkoxylated monoglyceride having from about 5 to about 40 moles of alkoxy units per mole of monoglyceride.

5. The demulsifier according to claim 4, wherein the alkoxylated monoglyceride is ethoxylated monoglyceride.

6. The demulsifier according to claim 1, wherein the acid having at least two carboxyl groups, full or partial ester thereof, anhydride thereof or combinations thereof has from about 4 to about 36 carbon atoms.

7. The demulsifier according to claim 1, wherein the acid having at least two carboxyl groups comprises an acid selected from succinic acid, adipic acid, glutaric acid, citric acid, and combinations thereof.

8. The demulsifier according to claim 1, wherein the fatty acid has from about 8 to about 22 carbon atoms.

9. The demulsifier according to claim 1, wherein the fatty acid comprises an acid selected from tallow fatty acids, tall oil fatty acids, palmitic acid, stearic acid, myristic acid, oleic acid, palmitoleic acid, linoleic acid, linolenic acid, and combinations thereof.

10. The demulsifier according to claim 6, wherein the molar ratio of the monoglyceride to the acid having at least two carboxyl groups, full or partial ester thereof, anhydride thereof or combinations thereof is from about 1:3 to about 5:1, and wherein the molar ratio of the monoglyceride to the fatty acid, fatty alcohol or combinations thereof, when used, is from about 1:3 to about 5:1.

11. The demulsifier according to claim 1, wherein the demulsifier has the general formula: 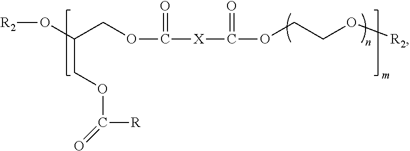
wherein m is a number from about 1 to about 50, the total n is a number from about 4 to about 200, R is a hydrocarbon having from about 7 to about 21 carbon atoms, X is a hydrocarbon having from about 4 to about 34 carbon atoms, and R₂ is hydrogen, a fatty acid, or a fatty alcohol.

12. A method of demulsifying an emulsion, wherein the emulsion is a water-in-oil emulsion or an oil-in-water emulsion, wherein the emulsion comprises a water component and an oil component, the method comprising the steps of:
adding the demulsifier of claim 1 to the emulsion, the water component of the emulsion, and/or the oil component of the emulsion; and
separating the emulsion into an oil phase and a water phase.

13. The method according to claim 12, wherein the demulsifier is added to the emulsion, the water component of the emulsion, and/or the oil component of the emulsion at a concentration from about 1 ppm to about 1000 ppm.

14. A method of making a demulsifier comprising the step of:
reacting a) a combination of a monoglyceride and polyethylene glycol (PEG) with b) an acid having at least two carboxyl groups, full or partial esters thereof, anhydrides thereof or combinations thereof and, optionally, a fatty acid, a fatty alcohol or combinations thereof.

15. The demulsifier according to claim 2, wherein the acid having at least two carboxyl groups, full or partial ester thereof, anhydride thereof or combinations thereof has from about 4 to about 36 carbon atoms.

16. The demulsifier according to claim 3, wherein the acid having at least two carboxyl groups, full or partial ester thereof, anhydride thereof or combinations thereof has from about 4 to about 36 carbon atoms.

17. The demulsifier according to claim 4, wherein the acid having at least two carboxyl groups, full or partial ester thereof, anhydride thereof or combinations thereof has from about 4 to about 36 carbon atoms.

18. The demulsifier according to claim 5, wherein the acid having at least two carboxyl groups, full or partial ester thereof, anhydride thereof or combinations thereof has from about 4 to about 36 carbon atoms.

19. The demulsifier according to claim 2, wherein the acid having at least two carboxyl groups comprises an acid selected from succinic acid, adipic acid, glutaric acid, citric acid, and combinations thereof.

20. The demulsifier according to claim 3, wherein the acid having at least two carboxyl groups comprises an acid selected from succinic acid, adipic acid, glutaric acid, citric acid, and combinations thereof.
